(19) United States
(12) Patent Application Publication
(10) Pub. No.: US 2012/0007772 A1
(43) Pub. Date: Jan. 12, 2012

(54) Controller for a Directional Antenna and Associated Apparatus and Methods

(76) Inventors: Aarno Tapio Pärssinen, Espoo (FI); Llkka Hakala, Helsinki (FI); Risto Kaunisto, Espoo (FI); Timo Karttaavi, Espoo (FI)

(21) Appl. No.: 13/256,800

(22) PCT Filed: Mar. 15, 2010
(86) PCT No.: PCT/IB10/00539

§ 371 Date: Sep. 15, 2011

(30) Foreign Application Priority Data
Mar. 16, 2009 (EP) PCT/EP2009/001926
Jun. 26, 2009 (GB) 0911067.7

(51) Int. Cl. H01Q 3/00; H01P 11/00

(52) U.S. Cl. 342/176; 343/757; 342/359; 342/175; 29/600

(57) ABSTRACT

A controller for a directional antenna, the controller configured to receive input signalling representative of a user's gaze direction. The controller is configured to generate output signalling for controlling the directionality of the directional antenna in accordance with the input signalling.

### TECHNICAL FIELD

The present disclosure relates to the field of a controller (e.g. one or more individual processing elements) for a directional antenna, and associated apparatus, methods, computer programs and devices. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Directional antennas, including phased array antennas, are known to focus a transmitted (or received) radio wave in a certain direction, instead of transmitting the energy in all directions (known as an isotropic case). Advantages associated with directional antennas can be a reduced cost in link requirements, and also the fact that less power needs to be transmitted in order to achieve a desired signal level for reception at a certain range and direction. Directional antennas can be used for directing a transmitted signal only to a certain receiver if the antenna beam is narrow enough. This can allow for selective transmission and reception based on the transmit/receive antenna orientation.

A known method for distinguishing between signals received from different radio terminals involves encoding a different identifier into the data transmitted by each of the radio terminals. Another known method involves using a very short range radio link, in which case the transmitter and receiver only establish a communications link when they are brought very close together.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided a controller for a directional antenna, the controller configured to receive input signalling representative of a user's gaze direction, and generate output signalling for controlling the directionality of the directional antenna in accordance with the input signalling.

It will be appreciated that the term “gaze direction” represents a direction in which a person/user is looking. Controlling a directional antenna in this way can enable the antenna to be economically and efficiently directed towards a third party device as identified by the user's gaze direction. Manual or electronic scanning of a scene for third party devices may not be required, and the associated overhead in terms of processing power, for example, may not be incurred. The third party device may be a transmitter such as a radio frequency identification (RFID) tag for embodiments where the directional antenna is a receiver. The third party device may be a receiver for embodiments where the directional antenna is a transmitter.

The output signalling may be configured to cause the directionality of the directional antenna to be substantially aligned with the gaze direction. In this way, a user can retrieve information from, or send information to, a device that they are looking at.

The input signalling may be receivable from an eye tracking module. The eye tracking module may be an iris tracking module or any other device that can determine a user's gaze direction.

The controller may be configured to generate an identifier of an angular sub-division of the user's gaze direction from the input signalling. The controller may process/use the identifier to generate the output signalling to control the direction of the directional antenna. The identifier may be a binary signal representative of a coordinate of the angular sub-division of a field of vision of a user.

The controller may be for a phased array directional antenna. It will be appreciated that other types of directional antennas may be used, and that in some examples any antenna that can compensate for time delays between signals received at different antenna elements can be used, irrespective of how such compensation is performed. In some examples, a “timed array” of antenna elements may be used with embodiments of the invention.

The controller may be for a directional antenna that uses millimetre-wave frequency spectrum signalling. The directional antenna may operate in the frequency range of 30 GHz to 300 GHz, and in some embodiments, the frequency range of 60 GHz to 90 GHz. The controller may be for a directional antenna that is a narrow beam-steering antenna.

The controller may be configured to provide for display of display data derived from signalling received at the directional antenna based on controlling the directionality of the directional antenna.

The directional antenna may be for providing reception and/or transmission of data. In the case of reception of data, this may be reception of data from an RFID tag.

There may be provided a user interface, apparatus, or portable electronic device comprising any controller described herein.

In another aspect, there is provided apparatus comprising an eye tracking module and a controller, wherein:
the eye tracking module is configured to generate gaze signalling representative of a user's gaze direction; and
the controller is configured to process the gaze signalling and generate output signalling for controlling the directionality of the directional antenna in accordance with the gaze signalling.

The apparatus may be a single device, or may be distributed over a plurality of devices. For example, components of the apparatus may comprise input and/or output ports to receive and/or transmit data to other components of the apparatus.

The apparatus may further comprise a directional antenna configured to receive the output signalling and control the directionality of the directional antenna in accordance with the output signalling.

The directional antenna may be configured to receive data from a radio frequency identification (RFID) tag. The RFID tag may be identified by the gaze signalling/gaze direction. The RFID tag can be active or passive. In embodiments where the RFID tag is active, the RFID tag may also comprise a narrow beam-steering antenna.

The apparatus may comprise a display. The display may be configured to display data derived from signalling received at the directional antenna. For example, the display may be configured to display data downloaded directly from RFID tags that have been identified from the user's gaze direction, or downloaded from a location identified by the signalling received at the directional antenna. In some examples a website address may be represented in the data received at the directional antenna such that information can be downloaded from the website and displayed to the user without the user having to access the website themselves.

The display may be part of the apparatus, or separate from it. For example, in some embodiments, the display may be associated with a headset, and in other embodiments the display may be located on a handheld electronic device such as a mobile telephone, a personal digital assistant, or the like.

The display may be semi-transparent such that data received at the directional antenna can be displayed on the display, and the scene from which the data has been received is visible through the display. This can provide for a convenient apparatus that enables data derived from signalling received at the directional antenna to be displayed in combination with the scene from which it was received.

The apparatus may comprise one or more of a headset, a heads-up-display, a near-to-eye display, a mobile telephone, a personal digital assistant, and a portable electronic device.

In another aspect, there is provided a system comprising an eye tracking module and a controller, wherein:
the eye tracking module is configured to generate gaze signalling representative of a user's gaze direction; and
the controller is configured to process the gaze signalling and generate an output signalling for controlling the directionality of the directional antenna in accordance with the gaze signalling.

In a further aspect, there is provided a method of controlling the directionality of a directional antenna, comprising:
receiving input signalling representative of a user's gaze direction; and
generating output signalling for controlling the directionality of the directional antenna in accordance with the input signalling.

There may be provided a computer program, recorded on a carrier, the computer program comprising computer code configured to provide any controller disclosed herein, any device disclosed herein, any apparatus disclosed herein, any system disclosed herein, or perform any method disclosed herein.

There may be provided a computer-readable storage medium having stored thereon a data structure configured to provide any controller disclosed herein, any device disclosed herein, any apparatus disclosed herein, any system disclosed herein, or perform any method disclosed herein.

There may be provided a computer program product comprising a computer-readable medium bearing computer program code embodied therein for use with a computer, the computer program code comprising:
code for receiving input signalling representative of a user's gaze direction; and
code for generating output signalling for controlling the directionality of the directional antenna in accordance with the input signalling.

There may be provided a computer-readable medium encoded with instructions that, when executed by a computer, perform:
receiving input signalling representative of a user's gaze direction; and
generating output signalling for controlling the directionality of the directional antenna in accordance with the input signalling.

There may be provided electronic distribution of any computer program disclosed herein.

There may be provided a method of assembling any apparatus, device or system disclosed herein.

In a further aspect, there is provided apparatus for a means for controlling a directional antenna, the apparatus comprising means for receiving input signalling representative of a user's gaze direction, and means for generating output signalling for controlling the directionality of the directional antenna in accordance with the input signalling.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates a controller according to an embodiment of the invention;

FIG. 2 illustrates schematically how a user's field of vision can be divided into angular sub-divisions according to an embodiment of the invention;

FIG. 3 illustrates a directional antenna according to an embodiment of the invention;

FIG. 4 illustrates a near-to-eye device according to an embodiment of the invention;

FIG. 5 illustrates schematically an application of an embodiment of the invention;

FIG. 6 illustrates schematically another application of an embodiment of the invention;

FIG. 7 illustrates schematically a process flow according to an embodiment of the invention; and

FIG. 8 illustrates schematically a data carrier according to an embodiment of the invention.

### DESCRIPTION OF EXAMPLE ASPECTS/EMBODIMENTS

One or more example embodiments described herein relate to a controller for a directional antenna, wherein the controller can generate output signalling for controlling the directionality of the antenna in accordance with a user's gaze direction. That is, the directional antenna can be pointed in a direction in accordance with the direction that a user is looking.

According to some embodiments of the invention, data can be received from a radio frequency identification (RFID) tag within a narrow directed beam of the directional antenna. The data can be displayed to a user, for example the received data may be displayed to the user in correspondence with the scene that they are looking at. In some examples, data can be downloaded from, and associated with, the location of its source.

Advantages associated with embodiments of the invention can include the provision of new consumer applications that can involve an interactive data exchange between an electronic device associated with the user and a third party electronic device, such as an RFID tag. Examples of new consumer applications can include the ability to be able to retrieve information/data from a scene in a new and interesting way for the consumer.

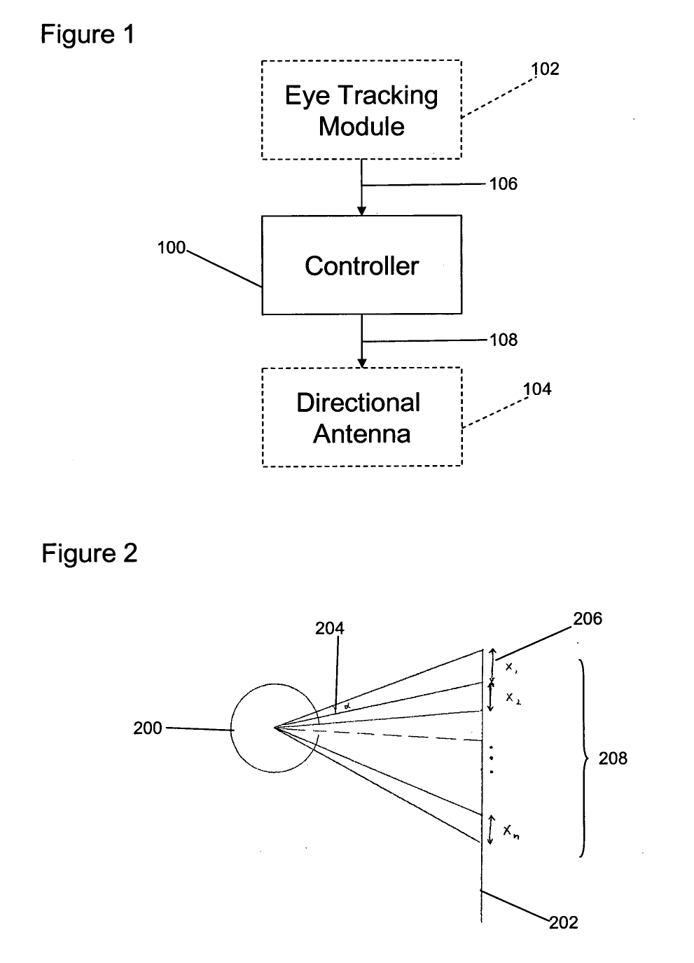

FIG. 1 illustrates a controller 100 according to an embodiment of the invention. The controller 100 is for a directional antenna 104, and is configured to receive input signalling 106 from an eye tracking module 102. The input signalling 106 comprises data representative of a user's gaze direction, and may be known as gaze signalling. It will be appreciated that the term “gaze direction” represents a direction in which a person is looking. As will be described in more detail below, the eye tracking module 102 may comprise an iris tracking module, or may comprise one or more motion sensors configured to determine a gaze direction based on relative motion of the eye, and/or motion of the head.

The controller 100 is configured to process the input signalling 106 in order to generate output signalling 108 for the directional antenna 104. The output signalling 108 is of a format that is configured to control the directionality of the directional antenna 104 in accordance with the gaze direction represented by the input signalling 106. Further details of an example of a directional antenna are provided below.

In some embodiments, it may be desirable for the directional antenna 104 to be pointed in the same direction as the user is looking. In other embodiments however, any other relative direction of the directional antenna compared with the gaze direction of the user may be required. For example, the controller 100 may be configured to direct the directional antenna 104 to receive data from a transmitter that is behind the user.

The controller 100 may be used to point the directional antenna 104 in the direction that the user is looking in order to receive/download data from a transmitter identified by the user's line of sight.

It will be appreciated that a “controller” can be a collection of one or more individual processing elements that may or may not be located on the same circuit board, or the same region/position on a circuit board. The same or different processor/processing elements may perform one or more of the (aforementioned or subsequent mentioned) functions.

FIG. 2 illustrates schematically how a user's field of vision can be divided into angular sub-divisions in order to classify a user's “gaze direction”. It will be appreciated that FIG. 2 is an illustration in a first dimension, and that a corresponding field of vision is present in a second dimension that is perpendicular to the first dimension. Processing of eye movement in the second dimension is substantially similar to that in the first dimension as described below.

A cross-sectional view of a user's eye is shown schematically as reference 200 in FIG. 2, and the vertical component of the user's field of view is shown as reference 208. In this example, the user's field of view 208 is split into a plurality of equal angularly defined sub-regions 206. An eye tracking module can be configured to monitor the location/movement of the user's iris to determine in which of the sub-regions 206 the user is looking. The determined sub-region 206 represents a user's gaze direction, and a value indicative of the determined sub-region can be provided as part of the input signalling 106 illustrated in FIG. 1, or can be generated by the controller 100 of FIG. 1.

In this example there are n angular sub-divisions 206 in both the x and the y dimension, and therefore the user's field of vision has an n² resolution of angular sub-regions 260 or “gaze states”. A binary code can be allocated to each gaze state, for example:

x₁y₁˜0001

x₁y₂˜0010

x₂y₂˜0011

These binary codes can be provided as output signalling 108 for controlling the directionality of the directional antenna 104.

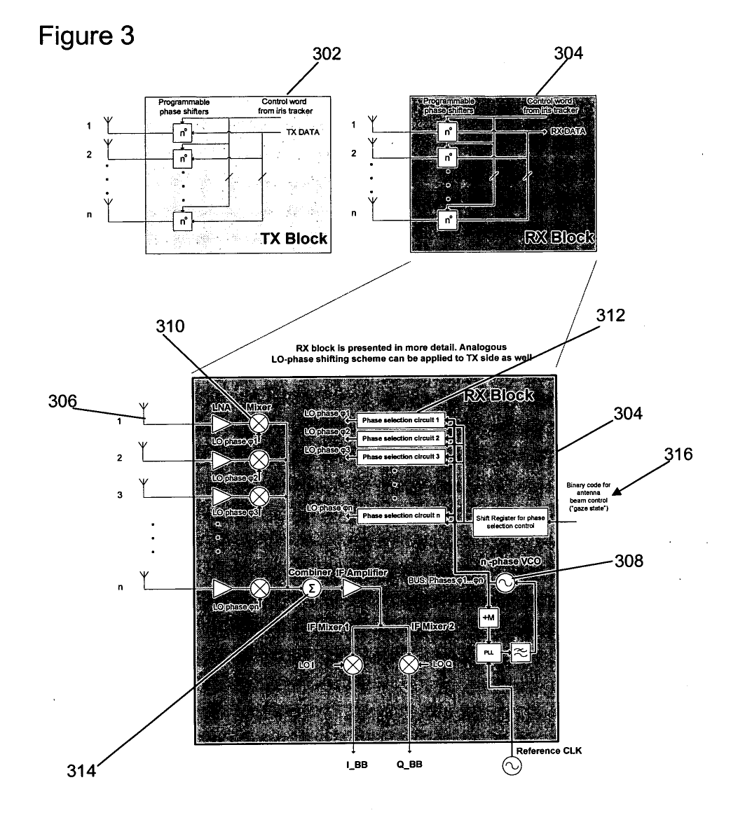

FIG. 3 illustrates schematically a phased array antenna that is an embodiment of a directional antenna. FIG. 3 illustrates a top level view of a transceiver, the transceiver comprising a transmitter 302 with a phased array antenna and a receiver 304 with a phased array antenna. The receiver 304 is also shown in more detail in FIG. 3. It will be appreciated that a local-oscillator phase shifting scheme can be applied to the transmitter 302 that is similar to that illustrated for the receiver 304.

A phased array receiver 304 consists of several signal paths, each of which is connected to a separate antenna element 306. For a general receiver case, a signal arrives at each antenna element 306 at a different time. A phased array ideally compensates for the time-delay between the elements 306 in order to coherently combine the signals received at each of the antenna elements 306 and thereby to enhance the overall reception from a certain direction while rejecting the reception from other directions. In a similar way, a time delay is inserted in each signal path in order to steer the transmission in a certain direction for transmission.

Adjustable time-delay elements can be used for this compensation in each of the signal paths from/to the antenna elements 306. However, at high frequencies true time-delay elements are difficult to realize and are usually approximated by using phase shifters if the system bandwidth is not prohibitively large. In essence, an adjustable phase shifter can be provided for each signal path. One way of implementing the phase shift is to use local oscillator (LO) phase shifting.

A single voltage controlled oscillator (VCO) 308 is used to generate the desired number of phase states that can be provided to the mixers 310 associated with each of the antenna elements 306. In this way, all of the phase states are accessible to the different signal paths. Each mixer 310 can independently receive a desired phase to be used as its local oscillator signal, and the desired phase for each signal path is determined by phase selection circuitry 312. Providing the desired phase signal to each of the mixers 310 causes a desired phase-shift to the down- (or up-) converted signal such that the down- (or up-) converted signals can be satisfactorily combined by combiner component 314.

The binary code representative of the user's gaze direction is provided as an input 316 to the phased-array receiver 304 in order to select a combination of phases for the signal path mixers 310 that correspond to the desired direction of the directional antenna, which in this embodiment corresponds to the gaze direction.

The binary code representative of the user's gaze direction may be a signal that is provided from an iris-tracking algorithm. It will be appreciated that the iris tracking algorithm may be performed by either a controller, or an eye tracking module, or a combination of the two.

Up until now, it has been difficult to provide personal communication devices with antennas that have this sort or directivity due to the small size of personal devices and the relatively low operating frequency. However, the development of millimetre-wave frequency beam steering technology has enabled new applications to be realised that were previously not possible.

Antenna directivity can be expressed as the half-power (−3 dB) beamwidth θ_{-3 dB}, and depends on the size of the antenna compared to the signal wavelength:

θ_{-3 dB}=58.4λ/D,
where D is the diameter of a circular antenna aperture with uniformly distributed illumination and λ is the wavelength. Using millimetre wave frequencies (such as 30-300 GHz, and in some examples 60 to 90 GHz), more directive links can be achieved with form-factors having dimensions that are suitable for handheld devices and/or headsets for example. At 90 GHz an antenna with 5×5 cm dimensions can optimally achieve a −3 dB beam width of 4°, which in some embodiments can be considered as sufficient for applications described herein.

Recent advances in semiconductor technology and CMOS technology in particular have made 60-90 GHz integrated electronics a potentially attractive/viable choice for portable devices.

Combining RFID type functionality with directive antennas can enable a user of a portable electronic device to select an information-containing “tag” by pointing towards its direction.

In other embodiments, if low-resolution beam steering is deemed adequate, the electrical (phased array) beam steering may be omitted altogether. In such an example, the antenna beam can be fixed and may be directed towards a desired direction only manually, for example by the user turning their face towards the target. Alternatively, if the antenna is not located in a near-to-eye device (NED), the antenna can be directed by manually pointing the device towards the target.

Millimetre-wave beam-steering using iris tracking can be implemented using phased-array technologies combined with iris monitoring video camera and an iris tracking algorithm. Depending upon the desired accuracy/resolution of the beam steering, the iris tracking algorithm can be set to provide a certain number of different “gaze states”. Each gaze state may represent a portion of the total scene visible to the user, for example a two-dimensional angular sub-division of the total scene. A different binary code can be allocated for each gaze state as described above with reference to FIG. 2.

The directing of the millimetre-wave radio beam can be accomplished using a combination of integrated millimetre-wave frequency ASICs/MMICs and planar antenna arrays. In some embodiments, the IC(s) can be embedded into NED of the user with the planar antenna array covering part of the outer surface of the NED. Alternatively, the IC(s) can be integrated directly into the antenna array if it is not incorporated into a NED.

In some examples, the scanning angle of the phased array can be approximately/substantially the same as the normal human eye viewing angle. It will be appreciated that the number of antenna elements that are provided dictates both the achievable angular resolution and the achievable scanning angle. In embodiments where the phased array is incorporated into a NED, the size and shape of the NED can be carefully designed in order to enable best possible user experience.

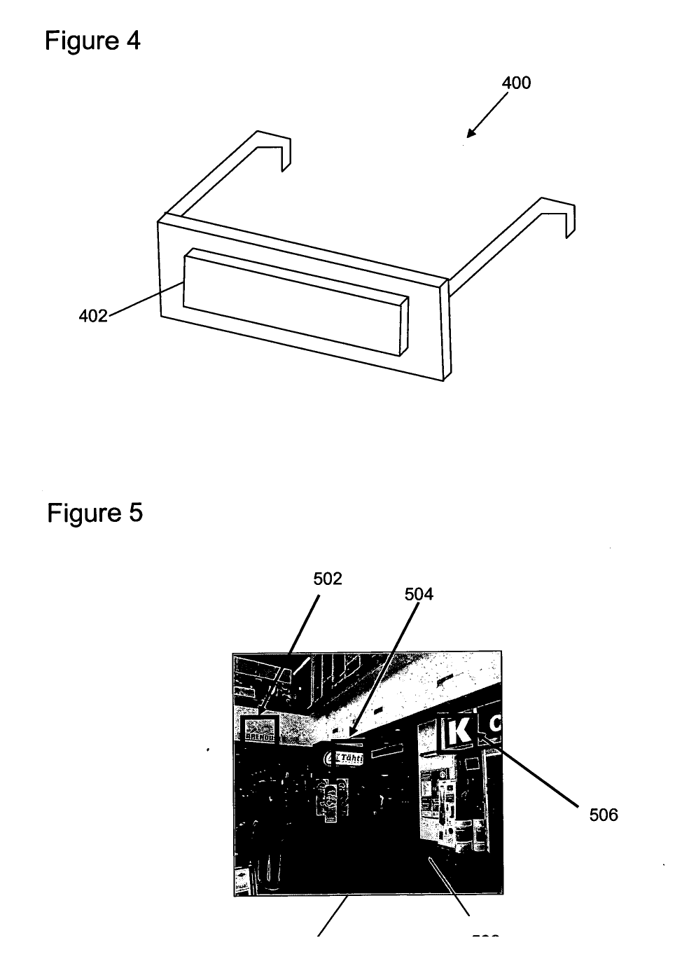

FIG. 4 illustrates a near-to-eye display (NED) 400 according to an embodiment of the invention. According to this embodiment, an antenna array, which may be a planar antenna array, is implemented on the NED 400 which can automatically align the antenna array in the direction that the user's face is pointing. In one embodiment, the antenna array is fitted to the surface of the NED 400 (in front of user's eyes), and a video camera is used to provide visual imagery of the surroundings. In another embodiment, the antenna array can be located outside of the user's field of vision (for example, on the forehead/other helmet-like setting) so that a video camera is not needed as the user can see the surrounding past the antenna.

In this embodiment, the direction of the antenna beam is controlled by tracking the user eyeball/iris movement and using that data in order to steer the antenna beam towards the gaze direction.

According to other embodiments, separate devices are used for tracking the eye movement and steering the antenna beam. In such embodiments, the antenna array could be located on the chest, or another body part of the user or even in a separate handheld device. A wireless communication connection (for example, using a wireless local area network (WLAN), Bluetooth, etc.) between the antenna array and the eye tracker can be utilized in order to provide the necessary feedback from the eye tracker to the antenna array for beam steering.

In such embodiments, a motion detector can be used in association with the antenna array carrying device in order to sense the alignment of the device and steer the antenna beam accordingly towards the gaze direction. That is, the alignment/orientation of the device that houses the antenna array can be taken into account to ensure that the antenna array is directed in a desired direction in accordance with the user's gaze direction. In some embodiments, a motion detector can also be associated with a user's head in order to sense the orientation of the user's head. This can provide coarse-resolution beam steering.

In this embodiment, eye/iris tracking can be performed using a small video camera integrated into the NED to monitor the eye motion. In other embodiments, the eye/iris tracking can also be performed using electrodes attached to the skin, or using other methods for direct access to the eye nerve(s).

In some embodiments, the NED 400 can comprise a display 402 for displaying information to a user. Two different types of display will be described.

The first type of display is a fully opaque display wherein imagery of the surroundings as captured by a video camera is displayed to a user. In addition to the imagery of the surroundings, information received by, or derived from, a signal received at the directional antenna can be superimposed on the imagery of the surroundings.

An example of information derived from a signal received at the directional antenna can include displaying information from a website, wherein data representative of the website address is received at the directional antenna. In such embodiments, a processor associated with the apparatus/system can download information from the website identified by the data received at the direction antenna so that the website can be displayed to the user in combination with the imagery of the surroundings.

This first type of display can be used to superimpose information derived from a mm-wave “tag” on an optical picture acquired with a video camera.

A second type of display is a see-through visor, so that the imagery of the surroundings can be seen directly by the user's eyes through the visor. In addition, the data/information derived from a mm-wave “tag” can be displayed on the see-through visor. Such an embodiment allows a real-time view of the surrounding scene with the additional “tag” information received by the directional antenna appearing on the display/screen when the user looks in a certain direction. The user can have the opportunity to either choose a target tag by looking at it in order to find out what information it offers, or to ignore the tag by not looking at it.

FIG. 5 illustrates an example display/user interface 500 according to an embodiment of the invention. The display shows a background image 508 that may be a direct view of the background through a semi-transparent display screen, or may be the display of captured video images.

Overlaid on the background image 508 are three squares 502, 504, 506 that represent the locations of data sources in the scene. In this example, the data sources are RFID tags. The user can look directly at one of the squares 502, 504, 506 in order to retrieve data from the data sources as described herein.

In some embodiments, only one of the squares 502, 504, 506 (representing the user's gaze direction) can be displayed at a time. In other embodiments, the locations of the data sources are always displayed to a user and further information is only retrieved from the data sources when the user looks directly at the data source.

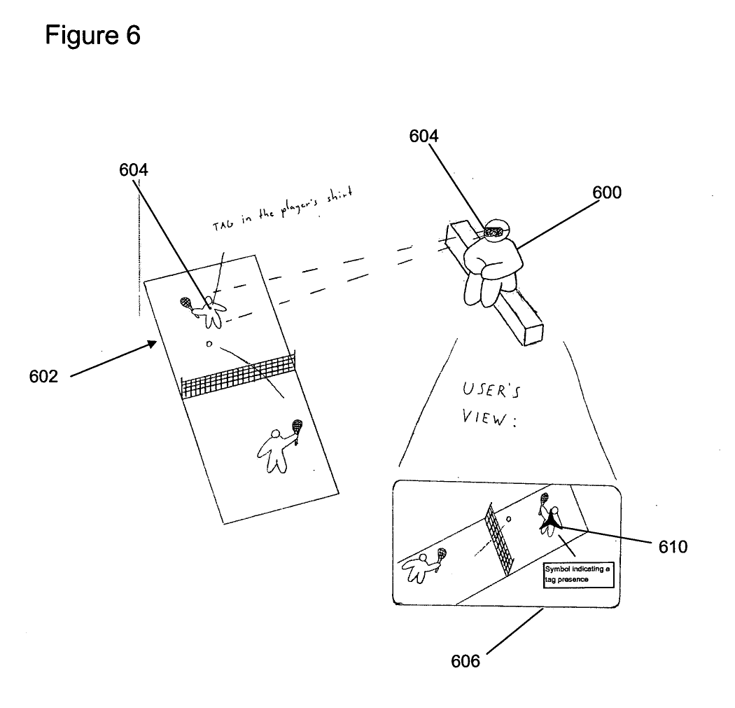

Embodiments of the invention can have applications that include creating an enhanced information environment in which a user can view additional tag information on top of their normal vision. An example could be a sporting event, for example, a tennis match as illustrated in FIG. 6.

FIG. 6 illustrates a user 600 watching a live tennis match 602 though a headset 608 according to an embodiment of the invention. The headset 608 may be similar to the NED of FIG. 4. The tennis players are each carrying a small mm-wave tag 604 included in their gear, for example in their shirt or in a shoe. The spectator can select a certain player for whom they desire additional information and/or statistics by looking at the certain player through the headset 608. The headset 608 would then determine the user's gaze direction by iris tracking, for example, and automatically direct a directional antenna towards the player that the user 600 is looking at. The mm-wave antenna beam would then detect the tag(s) carried by the player(s) and in this embodiment impose symbol(s)/icon(s) 610 on the screen of the headset 606 for the user 600 to select if further information is required. The symbols 610 may be coloured red or otherwise easily distinguishable from the background imagery. The symbols 610 may be selectable by the user using a user interface (not shown in the figures) associated with the headset 608 or another electronic device.

In other embodiments, the further information associated with a player may be automatically displayed on the headset 608 and user selection of a symbol/icon may not be required.

Another application of embodiments of the invention is an active gaming environment, for example a laser-pistol war game. In such applications, additional information, that would otherwise be invisible to the naked eye, can be made available to the player through their NED.

Yet another application of embodiments of the invention can be the integration of the NED into a helmet such as a bicycle helmet, law enforcement officer helmet, military helmet etc. Such an integration of the antenna array into the helmet form-factor may be easily implemented. In the case of a helmet, the antennas could be positioned so that they do not block the view of the user and a video camera may not be necessary for capturing an optical observation of the surroundings.

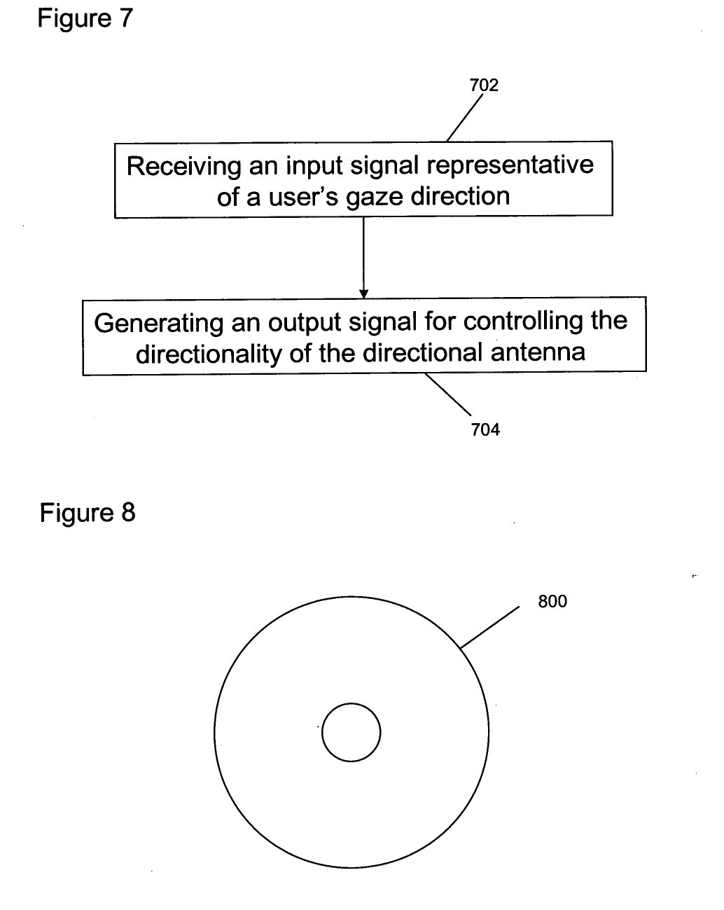

FIG. 7 illustrates schematically the process flow according to a method of the invention.

The process flow begins at step 702 by receiving an input/gaze signal representative of a user's gaze direction. As described above, the gaze signal can be received from an eye tracking module, which may be an iris tracking module in some embodiments.

At step 704, the process flow continues by generating an output signal for controlling the directionality of the directional antenna in accordance with the input signal. In some embodiments this may comprise directing the directional antenna in the same direction as the user's gaze (e.g. by using a motor). Directing the antenna in this way can enable data to be retrieved from (or sent to) a third party device at a location that the user is looking towards.

FIG. 8 illustrates schematically a computer/processor readable media 800 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

Although the majority of this disclosure is in relation to the use of a directional antenna acting as a receiver, it will readily be appreciated that the same principles can be applied for a directional antenna acting as a transmitter. For example, information/data can be transmitted to a data receiver as identified in accordance with a user's gaze direction.

One or more embodiments described herein can enable a user to obtain information from a data source, such as a RFID tag, by looking in the direction of the data source. In this way, a user can obtain information from tags that are not necessarily known to the user, or possibly not even detectable by eyesight alone. Embodiments described herein can avoid the need for electronic or manual scanning of an antenna as the desired directionality of the antenna can be determined from a signal representative of a user's gaze direction.

A concept described herein can be considered as offering a solution for any orientation and alignment problems arising when a beam-steerable antenna array is used for selective information transfer in a dynamic environment.

Embodiments of the invention can provide a user's apparatus (for example, a headset [HUD (Head Up Display) or NED (Near Eye Display)] or portable electronic device in general) containing eye/iris tracking facility for tracking the user's gaze direction. This data can be fed to an antenna array (for example in the millimeter wave spectrum 60-100 GHz) within said apparatus and tags can be searched for in that direction using a narrow radiation beam. If any tags are found, then this data can then be fed back to the user's apparatus for display on the display (for example the LCD) of say a mobile phone or on the display of the HUD.

It will be appreciated to the skilled reader that the apparatus/device/server and/or other features of particular apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the aforementioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

It will be appreciated that a “computer” can comprise a collection of one or more individual processors/processing elements that may or may not be located on the same circuit board, or the same region/position of a circuit board or even the same device. In some embodiments one or more processors may be distributed over a plurality of devices/apparatus. The same or different processor/processing elements may perform one or more of the (aforementioned or subsequent mentioned) functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A controller for a directional antenna, the controller configured to receive input signalling representative of a user's gaze direction, and generate output signalling for controlling the directionality of the directional antenna in accordance with the input signalling.

2. The controller of claim 1, wherein the output signalling is configured to cause the directionality of the directional antenna to be substantially aligned with the gaze direction.

3. The controller of claim 1, wherein the input signalling is receivable from an eye tracking module.

4. The controller of claim 1, wherein the controller is configured to generate an identifier of an angular sub-division of the user's gaze direction from the input signalling, and process the identifier to generate the output signalling.

5. The controller of claim 1, wherein the controller is for one or more of a phased array directional antenna, a directional antenna that uses millimetre-wave frequency spectrum signalling, and a directional antenna that is a narrow beam-steering antenna.

6. The controller of claim 1, wherein the directional antenna is configured to provide one or more of directional reception and transmission of data, including reception of data from a radio frequency identification tag

7. The controller of claim 1, wherein the controller is configured to provide for display of display data derived from signalling received at the directional antenna based on controlling the directionality of the directional antenna.

8. A user interface, apparatus or portable electronic device comprising the controller of claim 1.

9. Apparatus comprising an eye tracking module and a controller, wherein:
the eye tracking module is configured to generate gaze signalling representative of a user's gaze direction; and
the controller is configured to process the gaze signalling and generate output signalling for controlling the directionality of the directional antenna in accordance with the gaze signalling.

10. The apparatus of claim 9, further comprising a directional antenna configured to receive the output signalling and control the directionality of the directional antenna in accordance with the output signalling.

11. The apparatus of claim 10, wherein the directional antenna is configured to receive data from a radio frequency identification tag.

12. The apparatus of claim 10, wherein the directional antenna is a phased array antenna.

13. The apparatus of claim 10, wherein the directional antenna uses millimetre-wave frequency spectrum signalling.

14. The apparatus of claim 10, wherein the directional antenna is a narrow beam-steering antenna.

15. The apparatus of claim 9, wherein the apparatus comprises a display, the display being configured to display data derived from signalling received at the directional antenna.

16. The apparatus of claim 15, wherein the display is semi-transparent such that data received at the directional antenna can be displayed on the display, and the scene from which the data has been received is visible through the display.

17. The apparatus of claim 9, wherein the apparatus comprises one or more of a headset, a heads-up-display, a near-to-eye display, a mobile telephone, a personal digital assistant, and a portable electronic device.

18. A system comprising an eye tracking module and a controller, wherein:
the eye tracking module is configured to generate gaze signalling representative of a user's gaze direction; and
the controller is configured to process the gaze signalling and generate output signalling for controlling the directionality of the directional antenna in accordance with the gaze signalling.

19. A method of controlling the directionality of a directional antenna, comprising:
receiving input signalling representative of a user's gaze direction; and
generating output signalling for controlling the directionality of the directional antenna in accordance with the input signalling.

20. A computer program, recorded on a carrier, the computer program comprising computer code configured to provide the controller of claim 1.

21. A method of assembling an apparatus according to claim 9.

22. Apparatus for a means for controlling a directional antenna, the apparatus comprising means for receiving input signalling representative of a user's gaze direction, and means for generating output signalling for controlling the directionality of the directional antenna in accordance with the input signalling.

23. A computer program, recorded on a carrier, the computer program comprising computer code configured to perform the method of claim 19.
